(19) United States
(12) Patent Application Publication
(10) Pub. No.: US 2010/0083139 A1
(43) Pub. Date: Apr. 1, 2010

(54) VIRTUAL UNIVERSE AVATAR COMPANION

(75) Inventors: Christopher J. Dawson, Arlington, VA (US); Carl P. Gusler, Austin, TX (US); Rick A. Hamilton, II, Charlottesville, VA (US); Clifford A. Pickover, Yorktown Heights, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/238,501

(22) Filed: Sep. 26, 2008

(51) Int. Cl. G06F 3/048

(52) U.S. Cl. 715/757

(57) ABSTRACT

Methods, devices, program products and systems are disclosed for providing a virtual universe companion avatar for engagement with a virtual universe user avatar. In some methods a user of a virtual universe instigates a companion request. Profile data associated with the user is accessed from a data storage in response to the companion request, the profile data including a companion preference. A companion avatar is configured to engage a user avatar representing the user in the virtual universe, the configuring a function of processing the profile data, the engaging configured to meet the companion preference and an overriding user benefit agenda. The companion avatar is thus associated with the user avatar, wherein the companion avatar is configured to engage the user avatar by advancing the overriding user benefit agenda ahead of a virtual universe world provider benefit agenda.

### FIELD OF THE INVENTION

The present invention generally relates to providing interactive companions for Virtual Universe users, and more particularly to methods, systems, and program products for enabling Virtual Universe users to invoke and configure personal avatars customized and appropriate to user preferences for interpersonal communication interactions with the user's Virtual Universe avatar.

### BACKGROUND OF THE INVENTION

A Virtual Universe (VU) is a computer-based simulated world or environment; other terms for VU's include metaverses, “3-D Internet” and Virtual World, and VU will be understood to represent any of these environments. Users inhabit and traverse a VU, and interact with other VU users through the use of an avatar, a graphical representation of the user often taking the form of a cartoon-like human though any graphic image may be utilized. In order to participate within or inhabit a VU a user creates an agent which functions as the user's account, and upon which the user builds an avatar tied to an inventory of assets the user owns in the VU and associated with the agent.

VU assets, avatars, the VU environment, and anything presented to a user as visual information comprise Universally Unique Identifiers (UUID's) tied to geometric data distributed to users as textual coordinates, textures distributed to users as graphics files (in some examples as a JPEG2000 file), and effects data rendered by the user's client computer according to the user's preferences and user's computer system device capabilities. Many VU's are represented using three dimensional (3-D) graphics and landscapes and are populated by many thousands of users or “residents,” often resembling the real world or fantasy/fictional worlds in terms of physics, houses, landscapes and in interpersonal communications with other users.

Large robust VU's and massively multiplayer online games, such as for example Second Life® (SECOND LIFE is a trademark of Linden Research, Inc. in the United States and/or other countries), Entropia Universe™ (ENTROPIA UNIVERSE is a registered trademark of MindArk PE AB in the United States, other countries, or both), The Sims Online™ (THE SIMS ONLINE is a trademark of Electronic Arts, Inc in the United States, other countries, or both), and There™ (THERE is a trademark of Makena Technologies, Inc. in the United States, other countries, or both) render and display detailed, large and complex graphic environments within which users may travel and participate as if a character in an expressionistic or fantastical fictional world or within a realistic or representational approximation of real life.

VU's are also commonly defined with respect to VU regions, virtual areas of land within the VU typically residing on a single server, with each region amenable to provision and management by a one or more participating providers. The size and complexity and variety of resources found in a VU are related to the number of providers participating and hosting regions through server hosting. And the success of a VU may depend upon attracting users and keeping them engaged and participating in the VU environment, thereby adding value to the providers who bear the cost in providing VU region content and services (and correspondingly expect an appropriate level of multiple-user engagement as a return on their investment), as well as for other users who wish to engage many others in a large virtual community. For example an informational or service-related region managed by a governmental or non-profit organization may desire or expect a given level of VU user engagement and participation, and commercial region providers may desire to engage in a given level of commercial transactions (e.g. sales) or achieve a level of marketing exposure among VU users.

Participants in virtual universes may suffer from problems related to the solitary nature of the VU experience. Users typically act through their avatars alone, and their abilities to fully exploit all of the opportunities and possibilities of the virtual universe are limited by the extent of their own personal knowledge about activities and resources in the virtual universe, as well as the context provided by their own language, cultural and interpersonal skill sets. In one respect the experience of a VU user may be similar to that of a person travelling alone in real-life to a new country or other unfamiliar real world location: the VU user may not understand the local language, cultures or norms of the VU destination, and may have no friend or trusted guide at the destination to share the experience with, talk to, ask questions or interact with in a meaningful and satisfying way, or to suggest activities available that may be of interest to the user. Thus an un-chaperoned VU user may feel lost and uncomfortable in the VU, making the user less likely to find value in continuing to explore and engage the VU or to return for a subsequent engagement, and negatively impacting the expectations and investments of VU providers desiring user activity and engagement.

### SUMMARY OF THE INVENTION

Methods, devices and systems are disclosed for providing a virtual universe companion avatar for engagement with a virtual universe user avatar. In some methods a user of a virtual universe instigates a companion request. Profile data associated with the user is accessed from a data storage in response to the companion request, the profile data including a companion preference. A companion avatar is configured to engage a user avatar representing the user in the virtual universe, the configuring a function of processing the profile data, the engaging configured to meet the companion preference and an overriding user benefit agenda. The companion avatar is thus associated with the user avatar, wherein the companion avatar is configured to engage the user avatar by advancing the overriding user benefit agenda ahead of a virtual universe world provider benefit agenda.

In another aspect, service methods are provided comprising deploying applications for providing a virtual universe companion avatar for engagement with a virtual universe user avatar according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for providing a virtual universe companion avatar for engagement with a virtual universe user avatar. Moreover, systems, articles and programmable devices configured for performing one or more method and/or process elements of the current invention are also provided for providing a virtual universe companion avatar for engagement with a virtual universe user avatar, for example as described above.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram illustration of a virtual universe avatar and companion engagement according to the present invention.

FIG. 2 is a flow chart illustrating a process and system for providing virtual universe companion avatars according to the present invention.

FIG. 3 is a block diagram illustration of a companion avatar according to the present invention.

FIG. 4 is a block diagram illustrating an exemplary computerized implementation of a system and method for providing virtual universe companion avatars according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description; and

II. Computerized Implementation.

### I. General Description

As discussed generally above, participants in a virtual universe are known as users or residents and are associated with a life-like entity typically called an “avatar.” The participant can choose and customize both the basic appearance and also the attire of the avatar, including both positive and offensive appearances. The participant controls the actions, behavior, and interactions of his/her avatar with other participants, including both positive and offensive behaviors. The user's avatar represents an extension of the user into a unique VU world, and the experience for the user is enhanced in proportion to the degree with which the engagement of his avatar with other avatars in the VU approximates real-world person-to-person engagements.

The VU environment offers advantages in introducing and implementing real-world interpersonal communication skills and efficiencies in networked communications with other people and entities through their avatars. Rather than expending effort and time in translating communications and tasks into a computer application-specific inputs (for example, using a browser to a navigate to a web page and find a text dialog box, etc.), the VU user may simply immerse himself into VU and assume the role of his avatar, talking with other avatars and moving and grabbing objects as if in real-life. In one aspect, the ability of the VU to convey an illusion of entering another world is improved by reducing reminders to the user that he is only participating in a computer program, which bring the user back to reality and ruin the immersion experience, interfering with the suspension of disbelief necessary for entry and engagement of the non-real life VU environment.

Prior art methods and processes for providing help and guidance to VU users to improve their VU experience include tutorials and training sessions, and guidebooks, magazines and newsletters. However, users must generally actively seek out and avail themselves of such resources, requiring inconvenient investments of time, attention and effort by the user. Moreover, unless tailored to a user's individual needs a given resource may fail to efficiently match user learning styles. And guideline and tutorial resources are usually composed or programmed and then subsequently issued or implemented, providing a static, fixed resource that may become obsolete if not continuously updated to reflect the current state of a given VU. Interactive real-time help may also be offered through chat application interfaces, however the generally impersonal nature of chat encounters with help desks and other information provider services may be off-putting and inefficient in quickly and appropriately responding to the VU users needs, as well as offering a poor substitute for the company and companionship of a friend or other trusted fellow-traveler.

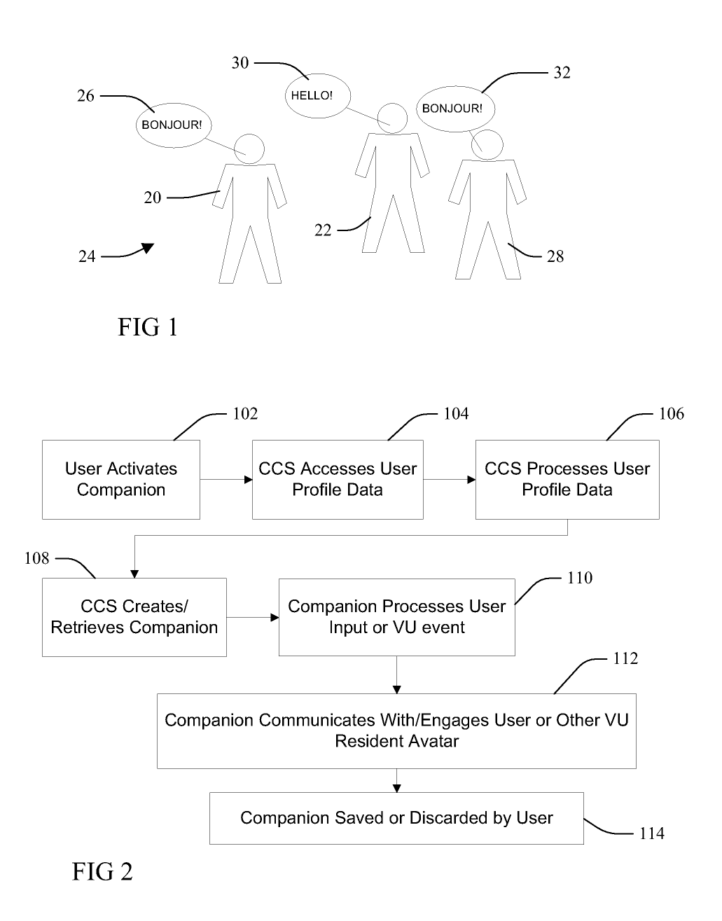

Referring now to FIG. 1, a VU user avatar 22 is illustrated engaging another, second avatar 20, and more particular as greeted by the second avatar 20 through a greeting communication 26 within a virtual universe 24. According to the present invention, a user of the user avatar 22 has also requested and thereby instigated the invocation of a companion avatar 28. The companion avatar 28 is configured in response to profile data associated with the user of the user avatar 22, the profile data comprising a companion preference. The companion avatar 28 is configured to meet the companion preference as a function of processing the profile data, and to responsively engage the user avatar 20 as a friend, guide or faithful companion. The companion avatar 28 is also configured to advance an overriding user benefit agenda, in one aspect ahead of a virtual universe provider benefit agenda. In the present example, it has been determined that the second avatar 20 presents a good interpersonal communication engagement opportunity, and as the second avatar 20 has initiated a conversation with a greeting 26 in a foreign language (French) not spoken by a user of the user avatar 22, the companion avatar 28 facilitates a conversation by translating a response 30 by the user avatar 22 in English into a French language response 32.

FIG. 2 illustrates a method and process according to the present invention for providing a companion avatar for engagement with a user avatar. At 102 a VU resident or user requests or activates a companion and at 104 a Companion-Creator System (CCS) accesses data and other information associated with the VU user comprising a user profile and analyses the profile information at 106. At 108 a companion is retrieved or created by the CCS as a function of processing the profile information and provided to the user as a companion avatar, the companion avatar configured with an overriding agenda that prioritizes serving for the benefit of the user avatar ahead of any benefit of the virtual world as a whole, and thereby enhancing the experience of a VU user in exploring and engaging a VU environment. More particularly, the companion is configured to make the VU life more enjoyable for the user avatar, and thus function as an advocate for the interests of the user avatar even where they may conflict with those of the VU world or a VU region provider, and further customized and tailored to meet the wants and needs of the avatar as reflected by the user profile.

An appropriate supervisory authority may have input in or exert control over creation or retrieval of an appropriate companion at 108. Thus, a parent or teacher may define or select permissible companion attributes and behaviors for a child user: for example at the creation of a VU user account for a child a parent may specifically limit possible companions, excluding characters or attributes associated with aberrant, deviant or poor behaviors, or selecting a set of permissible characters for companion selection. Employers and other commercial providers may likewise limit employee or customer companion avatar characters, attributes and behaviors to conform to one or more acceptable standards and norms.

The companion avatar is thus provided to interact with the user avatar during the user's engagement in the VU. At 110 the companion processes a user input, for example parsing chat or spoken dialogue directed at the companion avatar by the user/user avatar; or processes a VU event, for example reacting to a movement or action by the user avatar or another VU resident/user avatar (such as fetching a thrown stick in the case of a dog companion avatar) or to some other activity occurring within the VU. The input is then processed as a function of one or more objectives beneficial to the associated user, and at 112 the companion avatar communicates with or engages the user avatar with an appropriate response, and further one configured to advance one or more interest of the associated user as defined by the beneficial objectives. Thus, in one example, a pet dog avatar may wag his tail in reaction to the user avatar chatting/localizing a “you're a good dog” message, may warn a child user by barking if an unauthorized adult user avatar attempts to approach and engage the child user avatar, or growl at an advertiser-controlled avatar who attempts to intercede into a conversation between two resident avatars.

At 114 the user terminates his interaction with the companion, for example logging off from the VU or deactivating the companion while the user avatar is still engaged. Companions may be saved as an inventory asset associated with the user or otherwise saved or retained for future use by the user. Association of a companion with a user may also be ended at 114: examples include expiration of the companion, return of a companion to a service provider upon termination of rental or lease agreement, and selling the companion to another user or entity, and other possible termination scenarios will be understood by one skilled in the art.

Activating a companion at 102 or creating/retrieving a companion at 108 may comprise enabling the user to set companion attribute and/or presentation format preferences, and thus in one advantage of the present invention the VU experience of the user is enhanced through recognizing the preferences and desires of the user in providing an appropriate companion. In one embodiment, a user selects a “kind” of companion from a menu of choices, for example preferring and selecting one kind of companion over another depending on a particular VU social or business use or situation. User profile data or inputs entered at 104 may also comprise user inventory data (items in the inventory, etc.) and companion attribute and appearance preferences explicitly supplied by the user.

Processing of the user profile data at 106 may comprise analysis of the user's avatar friends, an analysis of the avatar's appearance, and other information such as profiles that exist outside or inside the VU. The Companion-Creator System may also be configured to learn from a history of prior user inputs and user-companion interaction data stored in one or more databases or storage means, choosing a companion as a function of the historical data. For example, if in the past a user has requested a companion avatar that had access to information through a specified on-line informational web page provider or service entity, and the user rates this access or information retrieved therefrom favorably, then the next time the user requests a companion the CSS will default to provide a companion having access to the same entity.

Retrieving or creating the companion avatar at 108 also comprises selecting or configuring a graphical depiction of the companion avatar as a function of user profile data including beneficial agendas and user preference inputs. The companion avatar may be a human character or otherwise have human appearance characteristics. For example, a new user to a VU having a user profile indicating shy or lonely behavioral characteristics or having accessibility needs may indicate providing avatar selection options at 102 or 104 that include a beautiful or handsome companion avatar with artificial intelligence capabilities, wherein the beautiful companion accompanies the user as he traverses the VU. Providing attractive human companion avatar's provides a number of advantages to the user in his VU environment experience. In one aspect, it has been shown that a person is judged by others to be more attractive, interesting, and valuable when he or she is accompanied by an attractive friend. People may also be perceived as non-threatening when they are with a friend.

In another aspect, a companion may be selected and configured to help a user overcome accessibility challenges, for example translating foreign language and technical jargon for a user or otherwise functioning as a communication facilitator. Thus, the companion may enabling interpersonal communication with other VU user avatars otherwise inaccessible to the user avatar, and may suggest other regions of the VU world with accessibility features appropriate to the user's level of capability.

Non-human companion avatars may also be provided. For example, simple animal or pet companions comprising less robust capabilities or artificial intelligence may be required or provided for the avatar, wherein a pet avatar may be of a kind that is deemed pleasing to the owner and with certain motion and sound characteristics.

The VU companion avatar can be created as a computer-controlled entity, a human-controlled entity or in a combination of human and computer-controlled configurations. A human-controlled companion may be controlled by an administrator or other human logged on or otherwise engaging the VU, or may be outside the virtual world and communicating via an interface to the VU; in one respect an in-VU presence by the human controller may be more useful and advantageous in that the human-controller is immersed in the VU environment. And a human-controlled companion can provide help and support for a user avatar based on the skills and experiences of the human controlling the virtual companion, and thus the value and capabilities of the human-controlled companion avatar are directly related to the value and capabilities of the human in control.

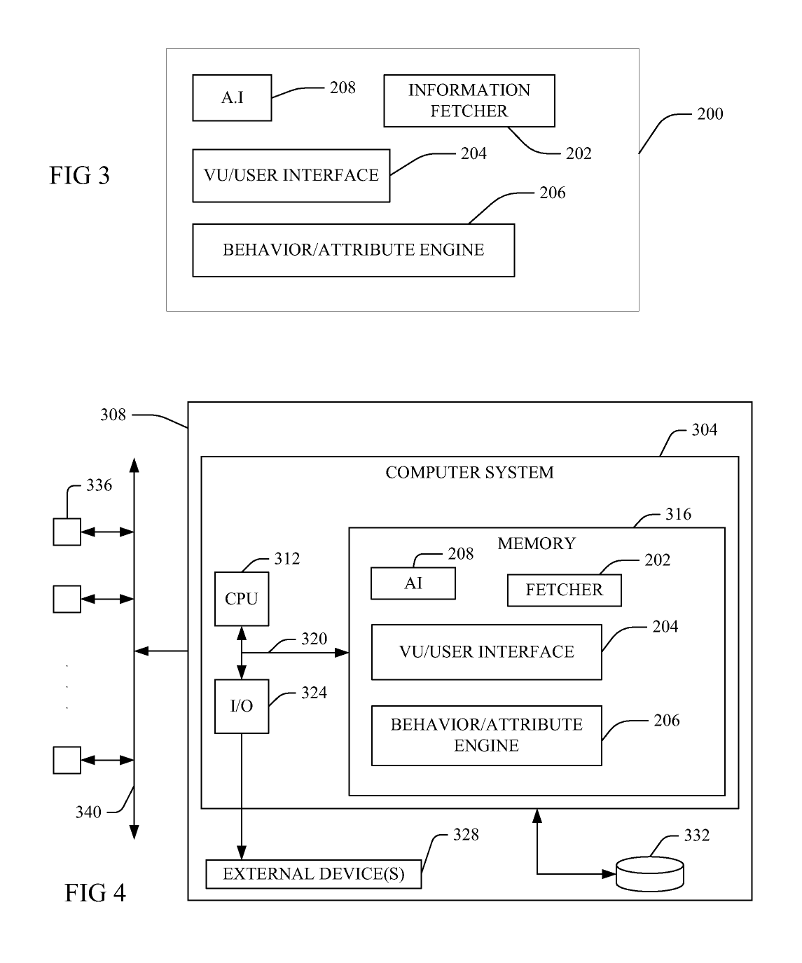

FIG. 3 illustrates an automated or computer-controlled companion avatar 200 according to the present invention. The computer-controlled virtual companion 200 comprises an information fetcher component 202 provided for retrieving information sought by the user or required by the companion avatar in order to respond to user's request or need. Information may be stored within the information fetcher 202 or retrieved from some other storage means or database in communication with the fetcher 202. The fetcher 202 may thus be instantiated with information and knowledge that is deemed useful for the avatar, and may have an associated inventory that it may withdraw items from as needed, for example including party accessories, business items, documentation, software scripts, maps or other information about the VU.

Fetcher 202 information can be created and maintained by VU owners or providers, in one aspect constantly updated to keep current, relevant and useful to an associated user avatar, for example comprising the names and location of all currently-opened and operating shops within a VU. The fetcher 202 may also have access to a plurality of divergent resources both inside and outside the VU, illustratively including on-line encyclopedias, book information (for example public library internet browser interfaces, and commercial text providers, and other informational resources, as will be appreciated by one skilled in the art. Information may also be stored by a VU provider or VU region provider and made available to any or all virtual companion avatars through communication with their information fetcher's 202.

Thus, in one advantage, multiple forms of information retrieval may be provided by one simple user-friendly companion avatar 200 functioning as a one-stop source of information, wherein the user avatar merely queries the companion avatar 200, the selection of appropriate sources and information retrieval takes place behind the scenes unknown to the user avatar, and the companion avatar 200 presents the results through a typical VU avatar interpersonal communication means (in one example through a chat dialog box) through a consistent persona of the companion avatar 200, thus enabling the user to remain immersed in the VU environment experience.

The companion 200 virtual universe and user interface component 204 and the behavior and attribute engine 206 are provided to engage the user avatar as well as the VU environment in general (thus other avatars), in one aspect enabling the companion avatar to process information provided by the information fetcher 202 as well as by the artificial intelligence learning component (AI) 208 to function as an advisor, colleague, pet, or friend in engaging a user avatar through the interface component 204. The attribute engine 206 may be instantiated with specific characteristics or traits that are appealing or wanted by an associated user. These traits may include visual information (how the virtual companion looks), audio (how the virtual companion sounds) or by behavior (how the virtual companion acts). In one advantage, the companion communicates directly with the user via his avatar and thus engages the user as any other VU resident avatar may within the engagement context provided by the VU (in effect, appearing to the participant as another user or character within the VU.) User avatars may communicate with virtual companion avatars through the interface component 204 by a variety VU communication means, including chat messages, audio voice recognition and hand signals, gestures or other signaling. Both computer-controlled and human-controlled virtual companions may thus converse or interact with the user avatar.

A user may summon a companion avatar (for example at process 102 of FIG. 2 discussed above) through a computer interface menu item available to the user or the user avatar, through a physical gesture by the user avatar (for example rubbing a lamp to awaken a companion “genie” avatar) or through a spoken or text-import trigger word, phrase, audio input (for example a double-finger snap) or some user avatar gesture. A companion may also be evoked in response to one or specific events, such as a query or request for help or information or other action by the user or his avatar indicating a desire for engaging the companion. In another aspect, a companion avatar may also be dismissed or deleted through one or more avatar gestures, inputs, etc., giving a user the ability to quickly and efficiently limit the visibility of a virtual companion to other VU users as needed and desired by the user associated with or owning the companion avatar.

The AI 208 enables the virtual companion to learn information from interactions with the user avatar and the VU environment. By watching actions and behaviors of the user avatar and other avatars during the life cycle of the virtual companion 200, the AI 208 may learn that the owner avatar likes to talk or act in a certain way and thereby enable the behavior and attribute engine 206 to mimic or utilize the observed user language and mannerisms and thus behave in a fashion similar to the user's avatar. The AI 208 may learn to choose specific preferred kinds of information sources based upon prior search and result invocations. The AI 208 may also track and store and learn from movements, actions, conversations or other actions and behaviors of a user avatar, for example remembering routes traveled between given VU destinations and responsively suggesting appropriate routes matching the user's preferences for future travels.

As in the real world, it is often necessary to have a companion to help with tasks that require the efforts of more than one person or someone that can answer questions, and other avatar/residents may not be readily available in the VU. In social settings, the presence of a VU companion according to the present invention may facilitate social interactions, making introductions, giving guidance, and simply acting as a point of visual attraction for others. The companion avatar 200 may also escort the avatar in unfamiliar areas within the virtual world by making cross-cultural introductions acting as a partner during a dance or assisting with other social functions.

In one advantage of the present invention, the virtual companion 200 may be configured purely for the benefit of the avatar, and hence without any unknown or outside agenda for the benefit of any other parties, such as VU advertisers, commercial sponsoring entities or VU world or region providers. The virtual companion can function as a good friend and who has the best interests of the avatar at heart; though other VU resident avatars may offer seemingly friendly help and support, one never knows if their offers of help are genuine, or whether they come from someone who has good intentions or has the appropriate knowledge. Thus the value and trustworthiness of the companion avatar 200 is a function of the transparency with which the companion 200 is programmed and functions, and a companion avatar 200 is more likely to be considered a trusted advisor, pet, or escort, and more likely to be useful to the user in living in and understanding the virtual world where clearly configured solely for the benefit of the associated user.

The virtual companion 200 may identify itself uniquely, as well as identify specific behavioral characteristics or attributes possessed by the companion avatar 200, through one or more audio and/or visual attributes communicated to the associated user by either the user interface 204 or the behavior/attribute engine 206 and recognizable and understandable by the associated user. For example, the companion 200 may graphically depict itself to the user as a human wearing certain clothing, and thus a tour guide companion 200 may wear a tour guide uniform. The companion 200 may also be configured with unique audio capabilities rendering them distinct from other regular resident/user avatars encountered in the VU.

Perceived attributes may also be variable and dependent upon user status or VU region or other specific context. For example a companion may be visible to every other avatar in a first VU region, but only to a subset of authorized residents occupying a second VU region, or still further only to an associated or “owning” user avatar or other user avatars specifically authorized by the associated or owning user. Both one-to-one and one-to-many mapping between virtual companions and user avatars may be provided, wherein a first dedicated-type virtual companion is visible and responsive only to a single owning or associated user avatar and a second multiple user-type virtual companion configured to interact with a plurality of different VU user avatars. “Private” or “public” companions may also be provided, with private companions restricted to serving one or more of a select subset of avatars and public companions made available to any VU user avatar.

Companion or companion components may be offered, supplied or managed by a VU provider, a VU region provider or other third party, for example by a companion-creator company that supplies VU users with a temporary or permanent companion avatar. A companion provider may charge a user based on many criteria, for example including duration of companion use, specific companion features or attributes, or information resources available for access by the companion. In some embodiments, if a VU user/resident is satisfied with a companion avatar, he may drag the companion to his inventory (or otherwise make a selection of the companion) and pay for the companion, the companion stored or saved as a user avatar inventory or as another traditional avatar associated with or accessible by the user.

Users may accumulate and trade companions with other users, in some applications wherein with each trade an originating companion creator company may get remuneration or receive some other value. Companion avatars may also be provided pursuant to a fee gathering mechanism and schedule, for example on a cost per day or cost for question asked basis. Divergent companion avatars may be separated into different classes or types of companions or companion service attributes and charged for accordingly, with companions having a range of skills offered at a variety of pricing schedules, for example companions able to provide translation services may cost more than companions configured to offer lower-skilled services. Human-controlled virtual companions having a variety of specific skills may also be offered, typically at a higher price point than automated or computer-controlled avatars possessing the same or similar skills.

Companions may also be offered for a limited time to new user avatars entering a virtual world or region, or as an incentive to enter a specific location or world. Companions may also be awarded based on activities or behavior of an avatar. And computer-controlled companions configured to constantly learn through processing VU experiences or other data inputs (for example incorporating the AI 208) may become more and more valuable to an associated user avatar, as well as to other potential user avatars, as time progresses, in one respect as a pet such as a dog learns to be a better companion over time.

Companion avatars may also engage or interact with other companion avatars. For example, companion avatars may be configured to provide each other with information; thus, a first companion without access to a desired information source may be enabled to make an information request to a second companion with access. In some embodiments, a request transmitted from a first companion and accepted by a second companion opens a communication channel between the companions, enabling the first companion to directly access the desired source through the second companion.

In another aspect, the use of virtual companions may be limited by a VU provider VU region provider or companion provider. For example, the hours of availability of a virtual companion may be limited to certain business hours (for example between 9 AM and 5 PM EST-US or during some other specific business time epoch), and in particular for human-controlled or human-managed computer-controlled companion avatars provided by a corporate entity wherein a supervising human is only available during business hours. Still other companions may be available around-the-clock (24 hours a day, seven days a week), in particular computer-controlled companion avatars as well as avatars controlled by humans directly or indirectly, such as by international corporation help-desk personnel. Companion aspects and attributes may also be dependent upon VU status or operational situations: for example availability or abilities of a companion avatar may be a function of CPU cycles, loading levels, or network bandwidth. They may also be VU-dependent, wherein a companion may be limited to a first VU or VU region, and unavailable in a second VU or VU region.

### II. Computerized Implementation

The present invention may be implemented using conventional software tools and methods applicable to virtual universes, for example within a stand-alone VU application, or as a plug-in to an existing VU application. The system and mechanisms described could be implemented in a hosting system or grid for a virtual universe or in client software for the virtual universe installed on a user's personal computer or other programmable device. Referring now to FIG. 4, an exemplary computerized implementation includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage system 332. In general, the processing unit 312 executes computer program code, such as the code to implement various components of the process and system for providing a VU companion avatar for engagement with a user's avatar illustrated in FIGS. 1-3 and described above, including the information fetcher 202, the VU/user interface 204, behavior and attribute engine 206 and artificial intelligence (AI) 208 components discussed above, which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboard, pointing device, display, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware. To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to provide a VU companion avatar for engagement with a user's avatar. To this extent, the computer-readable/useable medium includes program code that implements each of the various process steps of the invention.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation could be deployed, managed, serviced, etc. by a service provider who offers to implement, deploy, and/or perform the functions of the present invention for providing a VU companion avatar for engagement with a user's avatar, for example by licensing methods and browser or application server technology according to the present invention to an internet service providers (ISP) or cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the invention for providing a VU companion avatar for engagement with a user's avatar, and in return the service provider can receive payment from the customer(s) under a subscription and/or fee agreement and/or the service provider can receive payment from the sale of advertising content to one or more third parties.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for providing a virtual universe companion avatar for engagement with a virtual universe user avatar, comprising:
a user of a virtual universe instigating a companion request;
accessing profile data associated with the user from a data storage in response to the companion request, the profile data comprising a companion preference;
configuring a companion avatar to engage a user avatar representing the user in the virtual universe, the configuring a function of processing the profile data, the engaging configured to meet the companion preference and an overriding user benefit agenda; and
associating the companion avatar with the user avatar;
wherein the companion avatar is configured to engage the user avatar by advancing the overriding user benefit agenda ahead of a virtual universe world provider benefit agenda.

2. The method of claim 1, further comprising configuring the companion avatar by:
selecting a companion attribute from a plurality of pre-defined companion avatar attributes as a function of a correlation of the selected attribute with the companion preference and the overriding user benefit agenda; and
populating the companion avatar with the selected attribute.

3. The method of claim 2, further comprising forming the plurality of pre-defined companion attributes by selecting a subset of attributes from a plurality of possible avatar attributes, the selecting a function of a permission criteria entered by another party.

4. The method of claim 3, further comprising the companion avatar exhibiting the selected attribute to another virtual universe user as a function of a perceived virtual universe social situation.

5. The method of claim 4 wherein configuring the companion avatar is a function of analyzing an appearance of the user avatar or an appearance of a friend avatar.

6. The method of claim 5, further comprising:
observing at least one of a language use or a mannerism of the user avatar; and
dynamically updating the companion avatar to mimic the at least one of the observed language use and the observed mannerism.

7. The method of claim 6, further comprising configuring the companion avatar to directly communicate with a second companion avatar associated with a second avatar of a second virtual universe user;
wherein the companion avatar is enabled to make an information request to the second companion avatar; and
wherein the companion avatar is further enabled to open a direct connection to an information source in communication with the second avatar upon a granting of the information request by at least one of the second companion avatar and the second user.

8. The method of claim 7, further comprising:
parsing a message communication from the user avatar; and
the companion avatar composing and sending a message in reply to the parsed message, the reply message composed as a function of the companion preference and the overriding user benefit agenda.

9. A service for deploying a companion avatar for engagement with a user avatar within a virtual universe, comprising:
providing a computer infrastructure configured to:
access profile data associated with a user from a data storage, the data comprising a companion preference;
provide a companion avatar configured as a function of processing the profile data to engage a user avatar representing the user in the virtual universe, the companion avatar configured to engage the user avatar by meeting the companion preference and advancing an overriding user benefit agenda; and
associate the companion avatar with the user avatar;
wherein the companion avatar is configured to advance the overriding user benefit agenda ahead of a virtual universe provider benefit agenda.

10. The service of claim 9, the computer infrastructure configured to:
select a companion attribute from a plurality of pre-defined companion avatar attributes as a function of a correlation of the selected attribute with the companion preference and the overriding user benefit agenda, and as a function of a permission criteria entered by another party; and
populate the companion avatar with the selected attribute.

11. The service of claim 10, the computer infrastructure configured to:
observe at least one of a language use or a mannerism of the user avatar; and
mimic the at least one of the observed language use and the observed mannerism.

12. The service of claim 11, the computer infrastructure companion avatar configured to:
directly communicate with a second companion avatar associated with a second avatar of a second user;
make an information request to the second companion avatar; and
open a direct connection to an information source in communication with the second avatar upon a granting of the information request by at least one of the second companion avatar and the second user.

13. A method for providing a virtual universe companion avatar configured for engagement with a user avatar of a virtual universe user, comprising:
producing computer executable program code;
storing the code on a computer readable medium; and
providing the program code to be deployed and executed on a computer system, the program code comprising instructions which, when executed on the computer system, cause the computer system to:
provide a companion avatar configured as a function of processing profile data associated with a user to engage a user avatar representing the user in a virtual universe, the profile data comprising a companion preference, the companion avatar configured to meet the companion preference; and
associate the companion avatar with the user avatar;
wherein the companion avatar is further configured to engage the user avatar by advancing an overriding user benefit agenda ahead of a virtual universe provider benefit agenda.

14. The method of claim 13, the program code comprising instructions which, when executed on the computer system, causes the computer system to:
select a companion attribute from a plurality of pre-defined companion avatar attributes as a function of a correlation of the selected attribute with the companion preference and the overriding user benefit agenda and a permission criteria provided by another party; and
populate the companion avatar with the selected attribute.

15. The method of claim 14, the program code comprising instructions which, when executed on the computer system, causes the computer system to:
observe at least one of a language use or a mannerism of the user avatar; and
configure the companion avatar to mimic the at least one of the observed language use and the observed mannerism.

16. The method of claim 15, the program code comprising instructions which, when executed on the computer system, causes the computer system to configure the companion to:
directly communicate with a second companion avatar associated with a second avatar of a second user of the virtual universe;
make an information request to the second companion avatar; and
open a direct connection to an information source in communication with the second avatar upon a granting of the information request by at least one of the second companion avatar and the second user.

17. A programmable device comprising:
a processing means;
a memory in communication with the processing means, the memory comprising a logic component; and
a network interface in communication with the processing means and the memory;
wherein the processing means is configured to use the logic component to:
configure a companion avatar associated with a user avatar of a user of a virtual universe user as a function of processing profile data associated with the user to engage the user avatar, the profile data comprising a companion preference, the companion avatar configured to meet the companion preference; and
associate the companion avatar with the user avatar;
wherein the companion avatar is further configured to engage the user avatar by advancing an overriding user benefit agenda ahead of a virtual universe provider benefit agenda.

18. The programmable device of claim 17, wherein the processing means is configured to cause the companion avatar to exhibit a selected attribute to another virtual universe user as a function of a perceived virtual universe social situation.

19. The programmable device of claim 18, wherein the processing means is configured to:
observing at least one of a language use or a mannerism of the user avatar; and
dynamically update the companion avatar to mimic the at least one of the observed language use and the observed mannerism.

20. The programmable device of claim 19, wherein the processing means is configured to enable the companion avatar to:
make an information request directly to a second companion avatar associated with a second avatar of a second virtual universe user; and
open a direct connection to an information source in communication with the second avatar upon a granting of the information request by at least one of the second companion avatar and the second user.
